(19) United States
(12) Patent Application Publication
(10) Pub. No.: US 2008/0159408 A1
(43) Pub. Date: Jul. 3, 2008

(54) METHODS AND APPARATUS TO DECODE AND ENCODE VIDEO INFORMATION

(76) Inventor: Nikolay Nikolaevich Degtyarenko, Sarov (RU)

Correspondence Address: HANLEY, FLIGHT & ZIMMERMAN, LLC, 150 S. WACKER DRIVE, SUITE 2100, CHICAGO, IL, 60606, US

(21) Appl. No.: 11/748,190

(22) Filed: May 14, 2007

Related U.S. Application Data
(63) Continuation of application No. PCT/RU06/00709, filed on Dec. 27, 2006.

(51) Int. Cl. H04B 1/66

(52) U.S. Cl. 375/240.25; 375/E07.026

(57) ABSTRACT

Methods, apparatus, and articles of manufacture to decode and/or decode video information are disclosed. A disclosed example method involves selecting a video frame and a macroblock of the video frame to process. The example method also involves initiating a processing operation of the selected macroblock by a first thread, wherein the processing operation involves one of decoding the macroblock or encoding the macroblock. Also, when prediction information is required from a second frame being decoded or encoded by a second thread, the processing operation of the selected macroblock by the first thread is stalled until the prediction information is available.

### FIELD OF THE DISCLOSURE

This application is a continuation of International Patent Application Serial No. PCT/RU2006/000709, filed Dec. 27, 2006, the specification of which is hereby incorporated herein by reference in its entirety.

### BACKGROUND

In general, a video or video program is formed using a plurality of sequential still-picture frames organized temporally to create a motion picture when presented sequentially at a particular speed. Video production, video delivery, and video presentation typically involve encoding and/or decoding video information including the still-picture frames (i.e., video frames). For example, video information may be encoded to enhance the visual quality of a video presentation, to insert additional information (e.g., text, descriptors, closed-captioning, audio tracks, overlayed video, overlayed pictures, etc.), and/or to compress the video information to use less storage space and/or to decrease delivery time to a viewer. Example video encoding standards include, for example, H.263, Moving Picture Expert Group (“MPEG”) standards, H.264, VC-1, etc.

Videos can be generated using different frame rates (e.g., 7 frames/second, 15 frames/second, 30 frames/second, etc.) and different pixel resolutions. In any case, processing (e.g., encoding or decoding) video typically requires processing relatively large amounts of data. For example, decoding a 30 frames/second video requires decoding 30 still-picture frames for every second of video presented. If each still-picture frame is a standard definition resolution frame (e.g., 720×480 pixels), approximately 10 million pixels are processed and presented for each second of video. Processing such large amounts of information in a timely manner can require a considerable amount of processing power. In some cases, dedicated video systems are used to encode and/or decode video information. In other cases, general purpose or multi-purpose computers having general purpose processors and/or enhanced video processing capabilities (e.g., video processors) are used to encode and/or decode video information.

### BRIEF DESCRIPTION OF THE DRAWINGS

FIG. 1 depicts an example representation of a plurality of video frames processed (e.g., decoded or encoded) using a plurality of threads.

FIG. 2 is an example processor configured to decode and/or encode video information using a plurality of threads.

FIG. 3 is an example multi-processor system having a plurality of processors configured to operate cooperatively to decode and/or encode video information using a plurality of threads.

FIG. 4 is an example apparatus configured to decode and/or encode video information using a plurality of threads.

FIGS. 5A and 5B depict a flowchart representative of an example method that may be used to implement the example apparatus of FIG. 4 to decode and/or encode video information.

FIG. 6 is a block diagram of an example processor system that may execute the method represented by FIGS. 5A and 5B to implement the apparatus of FIG. 4.

### DETAILED DESCRIPTION

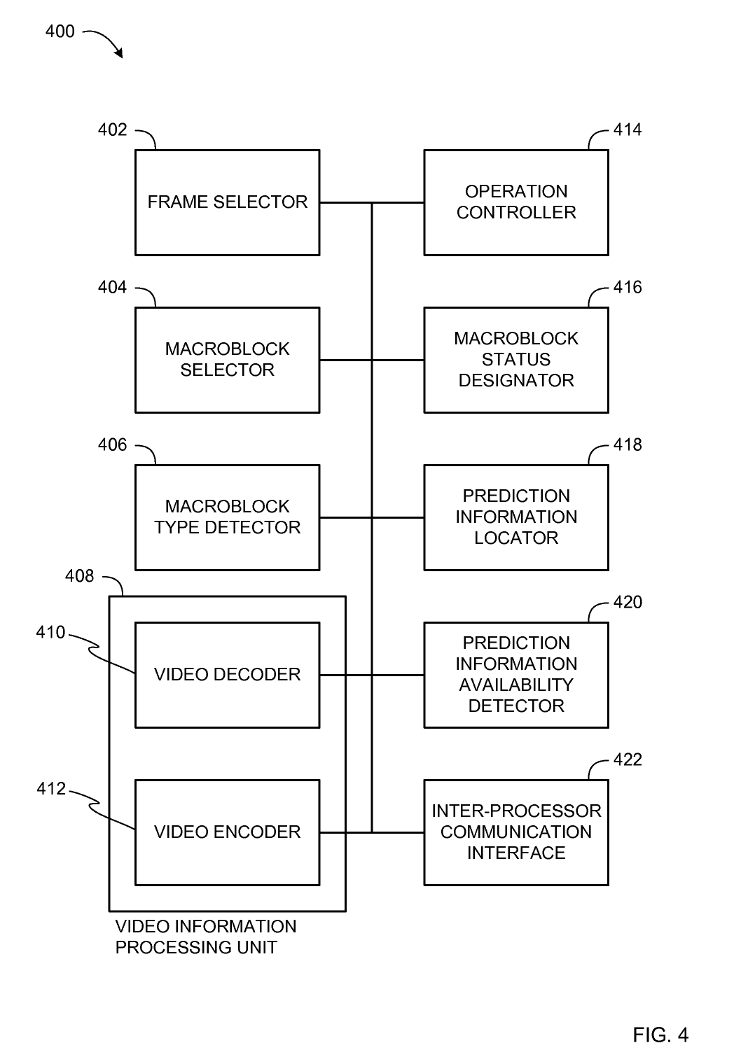

The example methods and apparatus described herein may be used to decode and/or encode video information using two or more threads. In particular, the example methods and apparatus are configured to use each of a plurality of threads to process (e.g., decode or encode) respective frames of a video program in parallel. In this manner, the example methods and apparatus described herein can be used to decode and/or encode video data or information (e.g., compressed video data or information) relatively faster and more efficiently than known methods and apparatus. In some example implementations, a single processor executes the plurality of threads. In other example implementations, a plurality of processors are communicatively coupled together and each of the processors executes one or more of the plurality of threads. In an example implementation, the example methods and apparatus described herein can be implemented in connection with an MPEG-4 decoder using the Open MP application program interface (API). Alternatively, the example methods and apparatus can be implemented in connection with other video decoding and/or encoding standards (e.g., video compression standards) including, for example, H.263, Moving Picture Expert Group (“MPEG”) standards, H.264, VC-1, etc. The example methods and apparatus can be implemented using a single processor (e.g.₇ the processor 202 of FIG. 3) or a multi-processor system (e.g., the multi-processor system 300 of FIG. 3).

Video standards include various manners in which to decode and/or encode video. Some video standards (e.g., Motion JPEG (MJPEG) or MJPEG2K) specify frames that are decoded/encoded independent (i.e., intraframes (I-frames)) from one another. Some techniques used to decode and/or encode video information that use only I-frames involve decoding or encoding a plurality of frames by decoding each frame independent of other frames. Other video standards specify using intraframes (I-frames) and predicted frames (P-frames or B-frames) and specify whether video frames should be sliced or not sliced. As discussed in greater detail below, predicted frames often have dependencies on information (e.g., prediction information) from other frames.

A sliced video frame is divided into slices (e.g., portions of the video frame), each of which can be decoded or encoded independent of other slices in the video frame, However, a non-sliced video frame is not divided into slices. For video information having sliced video frames, a video frame can be decoded or encoded by assigning a separate process thread to each slice of the frame. For video information having non-sliced video frames, known video decoding or encoding techniques often use a single process thread to decode or encode one non-sliced video frame. Although the example methods and apparatus described herein can be implemented in connection with video decoders and/or encoders associated with any of the above-described types of video standards, the example methods and apparatus are particularly advantageous for decoding and/or encoding video information having non-sliced video frames.

Some video encoding or video compression standards specify parsing video frames into a plurality of macroblocks that divide a video frame into a grid-like pattern having rows and columns of macroblocks. Macroblocks in a video frame are processed (e.g., decoded or encoded) sequentially from left to right in each row and the rows are processed sequentially from top to bottom. In addition, some video encoding or video compression standards specify different types of video frames and different types of macroblocks. Example video frame types include intraframes and interframes and example macroblock types include intramacroblocks and intermacroblocks.

A video frame of the intraframe type can be processed (e.g., decoded or encoded) independent of other frames. That is, an intraframe includes all of the information needed to decode or encode that frame. An intramacroblocks does not require information from other frames and can be processed using information in the current frame containing that intramacroblock. For example, the intramacroblock can be processed using information in the intramacroblock or in neighboring macroblocks within the same frame.

In contrast, a video frame of the interframe type is processed using information in the video frame and information in other video frames (e.g., reference video frames). An example type of interframe is a predicted frame (commonly referred to as a P-frame). To decode or encode a predicted frame requires obtaining prediction information from one or more reference frames (e.g., an intraframe or another interframe) and using the prediction information in connection with information in the predicted frame to process the predicted frame. An interframe includes intermacroblocks (e.g., predicted macroblocks) and often intramacroblocks. Decoding a predicted macroblock requires obtaining prediction information from one or more reference macroblocks in a reference frame. Predicted frames and predicted macroblocks may include unidirectional predicted macroblocks and/or bidirectional predicted macroblocks. Unidirectional predicted macroblocks use prediction information of reference macroblocks in previous frames. Bidirectional macroblocks can use prediction information of reference macroblocks in previous frames or future frames. The example methods and apparatus described herein may be used in combination with any one or more of the different video frame types and macroblock types described above.

Unlike some known systems that process (e.g., decode or encode) video frames in a serial manner, the example methods and apparatus described herein can be used to decode or encode video frames in parallel using a plurality of threads. For example, when a non-sliced video frame cannot be processed by a plurality of threads (unlike a sliced video frame that can be processed by a plurality of threads working in parallel to process respective slices of the frame), the example methods and apparatus described herein can be used to process a plurality of non-sliced video frames by assigning a separate process thread to each non-sliced video frame and processing each non-sliced video frame substantially in parallel. Thus, parallel processing can be advantageously used for processing non-sliced video frames using the example methods and apparatus described herein. In an example video decoding implementation, a first thread is used to decode a first frame of a video and a second thread is used to decode a second frame of the video. In the example implementation, the first and second threads decode the first and second frames in parallel. As described below, each thread can access progress or status information associated with the other thread. For example, the second thread can access status information associated with the first thread to determine how much of the first Frame or what portions of the first frame the first thread has decoded. In this manner, the first and second threads can use the progress or status information to control decoding operations when decoding portions of one frame is dependent on obtaining information (e.g., prediction information) from a decoded portion of another frame (e.g., a reference frame).

In another example video decoding implementation, the example methods and apparatus described herein can be used to implement a hybrid decoding process (or a hybrid encoding process) in which one or more threads decode a first plurality of frames in a sequential manner and one or more other threads decode a second plurality of frames in a parallel manner. For example, a hybrid decoding process may be divided into a serial decode sub-process and a parallel decode sub-process. The serial decode sub-process is implemented using operations executed by one or more threads to decode frames serially (e.g., decode a frame before decoding a subsequent frame). The parallel decode sub-process is implemented using operations executed by one or more threads to decode frames in parallel (e.g., decode two or more frames in parallel). The serial decode sub-process may be configured to use a single thread (or a plurality of threads) to decode one or more frames in a serial manner. For example, a first thread can decode a first frame and a second thread can decode a second frame after the first thread finishes decoding the first frame. The parallel decode sub-process may be configured to use a plurality of threads to decode two or more frames in parallel by using each of the plurality of threads to decode a respective frame. Each thread can access progress or status information associated with the processing status of other threads. An example video encoding process can be implemented to encode video in a similar manner.

An example method involves selecting a video frame and a macroblock of the video frame to process. The example method also involves initiating a processing operation (e.g., a decoding operation or an encoding operation) of the selected macroblock by a first thread. Also, when prediction information is required from a second frame (e.g., a reference frame) being decoded or encoded by a second thread, the processing operation of the selected macroblock by the first thread is stalled until the prediction information is available. For example, the processing operation may be stalled until the second thread has processed at least one reference macroblock including the at least some of the prediction information. In an example implementation, the first thread is executed by a first processor and the second thread is executed by a second processor.

In an example implementation of the example method, the prediction information is required if the macroblock type is not an intramacroblock. A macroblock type of the selected macroblock can be determined based on information in the selected macroblock. Also, coordinates of a region in a reference frame having at least some of the prediction information can be determined based on the information (e.g., motion vectors) in the selected macroblock.

In an example implementation of the example method, a macroblock index value (e.g., a coordinate value) corresponding to the selected macroblock can be set to a column number and a row number indicating a coordinate location of the selected macroblock within the selected video frame. In addition, prior to initiating the processing operation, a plurality of macroblocks in the selected video frame (e.g., all macroblocks of the selected video frame) may be marked or designated as not processed to indicate that the plurality of macroblocks are not ready to provide prediction information to a third thread to decode or encode a third video frame. After processing the selected macroblock, the selected macroblock can be marked or designated as processed.

An example apparatus includes a video information processing unit configured to use a first thread to perform a processing operation (e.g., a decode operation or an encode operation) on a first macroblock. The example apparatus also includes an operation controller configured to stall the processing operation of the first macroblock by the first thread when prediction information is required from a second frame (e.g., a reference frame) being decoded or encoded by a second thread and the prediction information is not yet available. For example, the example apparatus may include a prediction information availability detector configured to determine when the prediction information is available by determining when the second thread has processed at least one reference macroblock including the prediction information. In an example implementation, the prediction information availability detector is configured to determine when the prediction information is available based on a macroblock index value associated with the second frame indicative of a reference macroblock being decoded or encoded by the second thread.

In some example implementations, the example apparatus is provided with a macroblock type detector configured to determine the macroblock type of the first macroblock. The operation controller may be configured to stall the processing operation of the first macroblock by the first thread when the macroblock type detector determines the macroblock type of the first macroblock is not an intramacroblock type indicating, for example, that prediction information is required to process the first macroblock.

In an example implementation, the example apparatus is provided with a macroblock selector configured to set a macroblock index value corresponding to the first macroblock. The macroblock index value may be accessible by the second thread. To designate or mark the first macroblock as not processed prior to performing the processing operation on the first macroblock, the example apparatus may be provided with a macroblock status designator. Designating the first macroblock as not processed indicates that prediction information in the first macroblock is not available to a third thread to decode or encode a third macroblock. After the video information processing unit processes the first macroblock, the macroblock status designator designates or marks the first macroblock as processed.

The example apparatus may be implemented using a single processor that executes the first and second threads. Additionally or alternatively, the example apparatus may be implemented using a multi-processor system having a plurality of processors. In this manner, a first one of the processors can execute the first thread and a second one of the processors can execute the second thread. In an example implementation, the example apparatus is provided with an inter-processor communication interface configured to enable communications between the first and second processors.

As will be readily apparent to one of ordinary skill in the art, the example methods and apparatus described herein may be implemented using instructions stored on one or more machine accessible media (e.g., a CD-ROM, a magnetic storage device, an optical storage device, a solid-state storage device, etc.) associated with one or more processors or network system devices. In this manner, the machine accessible media may be used to enable the processors or network system devices to retrieve and execute the instructions to implement the example methods and apparatus described herein.

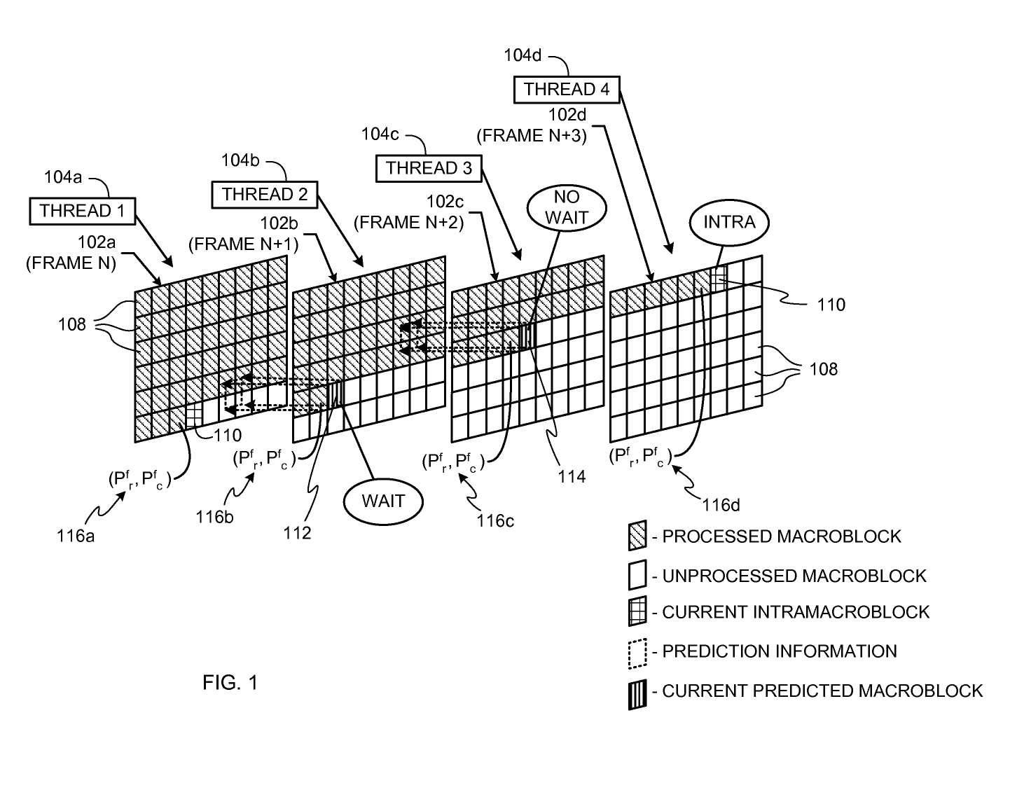

Turning now to FIG. 1, a representation of an example video processing operation 100 (e.g., a decoding operation or an encoding operation) is depicted as processing a plurality of video frames 102 using a plurality of threads 104. In the illustrated example, a first frame 102a (Frame N) is an intraframe, a second frame 102b (Frame N+1) and a third frame 102c (Frame N+2) are predicted frames (i.e., interframes), and a fourth frame 102c (Frame N+3) is an intraframe. However, in other example implementations, the first and fourth frames 102a and 102d can be interframes (e.g., predicted frames).

In a video decoding implementation, a first thread 104a is initiated to perform a video decoding operation of the first frame 102a, a second thread 104b is initiated to perform a video decoding operation of the second frame 102b, a third thread 104c is initiated to perform a video decoding operation of the third frame 102c, and a fourth thread 104d is initiated to perform a video decoding operation of the fourth frame 102d. In a video encoding implementation, the threads 104a-d are initiated to perform encoding operations on respective ones of the frames 102a-d.

Each of the frames 102a-d includes a plurality of macroblocks including unprocessed macroblocks 106, processed macroblocks 108, current intramacroblocks 110, and current predicted macroblocks 112 and 114. The unprocessed macroblocks 106 are macroblocks that, in a decoding implementation, have not been decoded or that, in an encoding implementation, have not been encoded. The processed macroblocks 108 are macroblocks that have been decoded (or encoded). The current intramacrobloclcs 110 are macroblocks that are in the process of being decoded (or encoded) and do not require prediction information. The current predicted macroblocks 112 are macroblocks that are in the process of being decoded and that require prediction information from a reference frame to be decoded (or encoded).

Each of the threads 104a-d is configured to access information associated with the other threads 104a-d to, for example, determine decoding or encoding statuses associated with the threads 104a-d. To indicate decoding and/or encoding statuses of the threads 104a-d, each of the frames 102a-d is associated with a respective macroblock index value 116a-d. In the illustrated example, the macroblock index values 116a-d are shown as macroblock coordinates (P^{f}ᵣ, P^{f}_{c}) that indicate a location of a current macroblock that is in the process of being decoded (or encoded). In the macroblock coordinates (P^{f}ᵣ, P^{f}_{c}), a frame value (f) indicates a frame number (e.g., frame N, frame N+1, etc.), a row value (r) indicates a row number within a frame, and a column number (c) indicates a column number within the frame. In the illustrated example, each of the threads 104a-d can access and update its own macroblock index value (e.g., one of the macroblock index values 116a-d). In addition, each of the threads 104a-d has at least read access to the other ones of the macroblock index values 116a-d.

To indicate which macroblocks are unprocessed (e.g., the unprocessed macroblocks 106) or processed (e.g., the processed macroblocks 108), the threads 104a-d can mark tile unprocessed macroblocks with a value or information (e.g., a processed status designator) indicative of an processed/unprocessed status. In some example implementations, to mark the unprocessed and processed macroblocks, each of the threads 104a-d can populate one or more example data structures (e.g., look-up tables) (not shown) with the unprocessed and processed status information. Each of the threads 104a-d can populate its own data structure corresponding to its respective one of the frames 102a-b. In this case, a data structure includes a plurality of entries, each of which corresponds to one of the macroblocks of a respective one of the frames 102a-d. Alternatively, all of the threads can populate a common data structure corresponding to all of the frames 102a-b. In any case, all of the threads 104a-d can access the macroblock status information of all of the frames 102a-d.

In an example implementation, the threads 104a-d can use the macroblock index values 116a-d and the macroblock status information to determine when prediction information is available to decode (or encode) one of the current predicted macroblocks 112 and 114. For example, in an example decoding implementation, the current predicted macroblock 112 of the second frame 102b requires prediction information contained in one or more macroblocks of the first frame 102a (e.g., a reference frame). The second thread 104b can determine the location (e.g., the macroblocks) within the first frame 102a having motion vectors information (e.g., motion vectors of objects that move positions from frame to frame) and retrieve the macroblock index value 116a and/or the macroblock status information associated with the first frame 102a to determine if/when the prediction information is available in the first frame 102a. In this manner, if the second thread 104b begins processing the current predicted macroblock 112 before thle first frame 102a has decoded the macroblocks in the first frame 102a having the required prediction information, the second thread 104b can stall the decoding operation of the current predicted macroblock 112 and wait until the first thread 104a processes the macroblocks in the first frame 102a having the required prediction information. When the second thread 104b determines that the prediction information is available from the first frame 102a, the second thread 104b can continue the decoding operation of the current predicted macroblock 112 to retrieve and use the prediction information from the first frame 102a.

In the same example decoding implementation, the third frame 102c includes the current predicted macroblock 114 that requires prediction information from the second frame 102b (e.g., a reference frame). As shown in the illustrated example, when the third thread 104c begins a decoding operation of the current predicted macroblock 114, the second thread 104b has already processed the macroblocks of the second frame 102c containing the prediction information required to decode the current predicted macroblock 114. When the third thread 104c retrieves the macroblock index value 116b and/or the macroblock status information associated with the second thread 102b and determines that the prediction information is already available, the third thread 104c need not stall the decoding operation, but instead can immediately retrieve the prediction information from the second frame 102b to decode the current predicted macroblock 114.

In an example encoding implementation, each of the threads 104a-d can determine which macroblocks require prediction information and mark those frames as predicted macroblocks (e.g., the current predicted macroblocks 112 and 114). When the second thread 104b begins processing the current predicted macroblock 112, the second thread 104b can determine the location (e.g., the macroblocks) within the first frame 102a having the prediction information and retrieve the macroblock index value 116a and/or the macroblock status information associated with the location in the first frame 102a to determine when the prediction information is available in the first frame 102a. In this manner, if the second thread 104b begins processing the current predicted macroblock 112 before the first frame 104a has encoded the macroblocks in the first frame 102a having the required prediction information, the second thread 104b can stall the encode operation of the current predicted macroblock 112 and wait until the first thread 104a encodes the macroblocks in the first frame 102a having the required prediction information. When the second thread 104b determines that the prediction information is available from the first frame 102a, the second thread 104b can continue the encoding operation of the current predicted macroblock 112 using the prediction information from the first frame 102a.

The threads 104a-d can be executed using a single processor or a plurality of processors communicatively coupled to each other. In an example implementation using two processors, a first one of the processors can execute the first and second threads 104a-b and a second one of the processors can execute the third and fourth threads 104c-d. Although four threads (the threads 104a-d) are shown in the illustrated example, other example implementations may be configured to use fewer or more threads. Accordingly, although four frames (the frames 102a-d) are shown, fewer or more frames can be processed (e.g., decoded or encoded) in parallel.

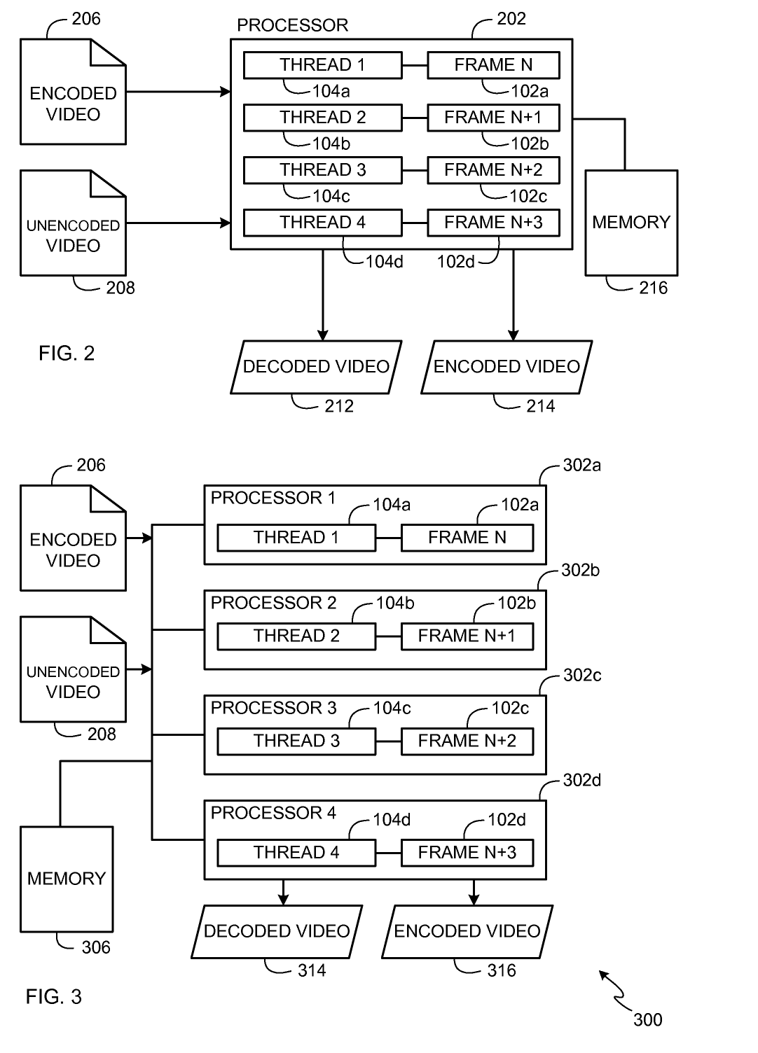

FIG. 2 is an example processor 202 configured to decode and/or encode video information using the plurality of threads 104a-d of FIG. 1. As shown, the example processor 202 receives encoded video information 206 (e.g., compressed video) and/or unencoded (raw) video information 208, uses the threads 104a-d to process the frames 102a-d of FIG. 1 in parallel as described above, and outputs decoded video 212 during a decode process or encoded video 214 during an encode process. To store the macroblock index values 116a-d (FIG. 1) and/or the macroblock status information described above in connection with FIG. 1, the example processor 202 is communicatively coupled to a memory 216. The memory 216 may also be used to store macroblock and frame data while processing the frames 102a-d.

FIG. 3 is an example multi-processor system 300 having a plurality of processors 302a-d configured to operate cooperatively to decode and/or encode video information using the plurality of threads 104a-d of FIG. 1. In the illustrated example, the processors 302a-d are communicatively coupled to each other. To store the macroblock index values 116a-d (FIG. 1) and/or the macroblock status information described above in connection with FIG. 1, the example processors 302a-d are communicatively coupled to a shared memory 306. In the illustrated example, each of the processors 302a-d executes a respective one of the plurality of threads 104a-d to process (e.g., encode or decode) a respective one of the plurality of frames 102a-d of FIG. 1 as described above. As shown, the example processors 302a-d receive the encoded video 206 (e.g., compressed video) and/or the unencoded (raw) video 208 and execute the threads 104a-d to process tile frames 102a-d in parallel. In the illustrated example, the processor 302d is configured to output decoded video 314 and/or encoded video 316. For example, in an example decoding implementation, the processor 302d organizes the frames decoded by the processors 302a-d and outputs the decoded video 314. In an example encoding implementation, the processor 302d organizes encoded frames produced by the processors 302a-d according to, for example, a video compression standard and generates the encoded video 316.

Although each of the processors 302a-d is shown as executing one thread, in other example implementations, each of the processors 302a-d can execute multiple threads. In addition, in other example implementations, the example multi-processor system 300 can be implemented using fewer or more processors.

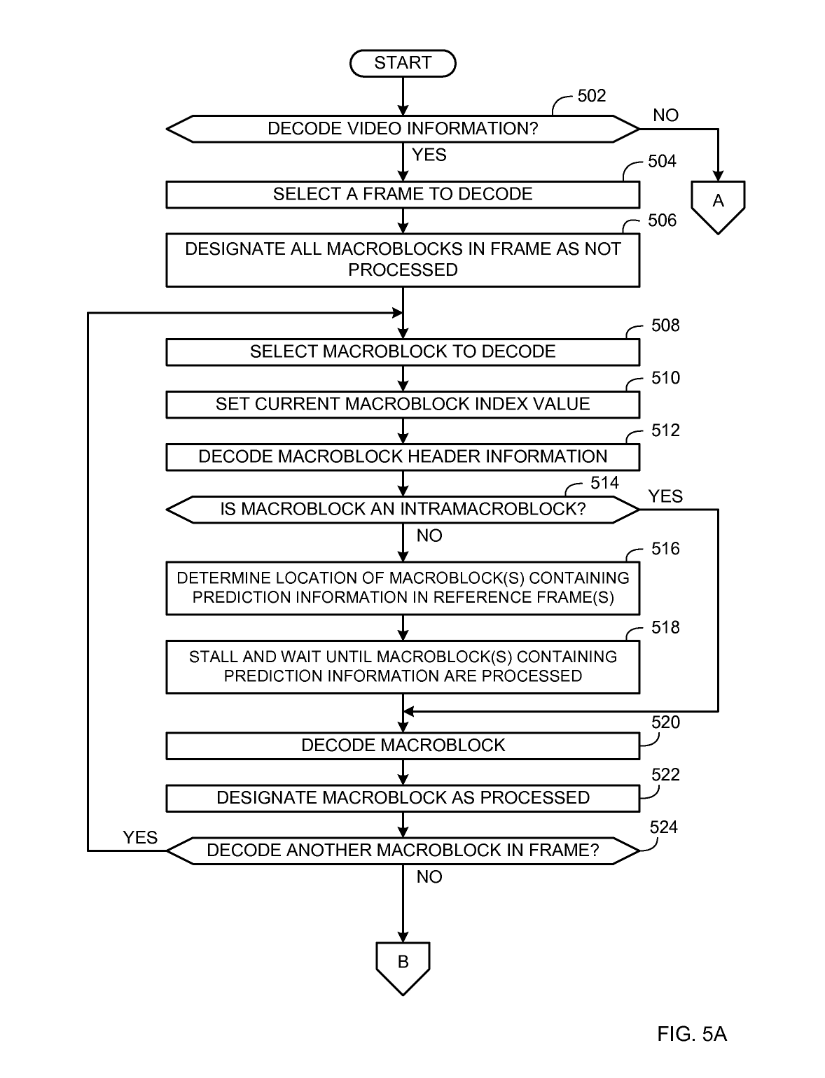

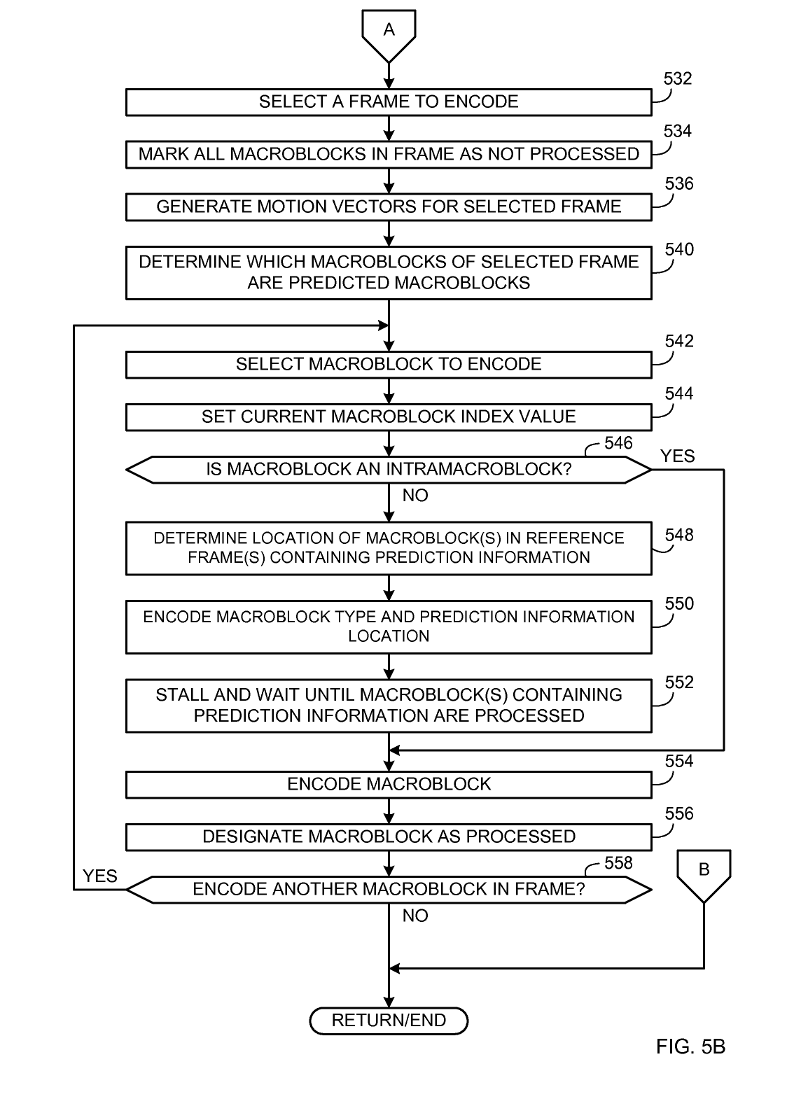

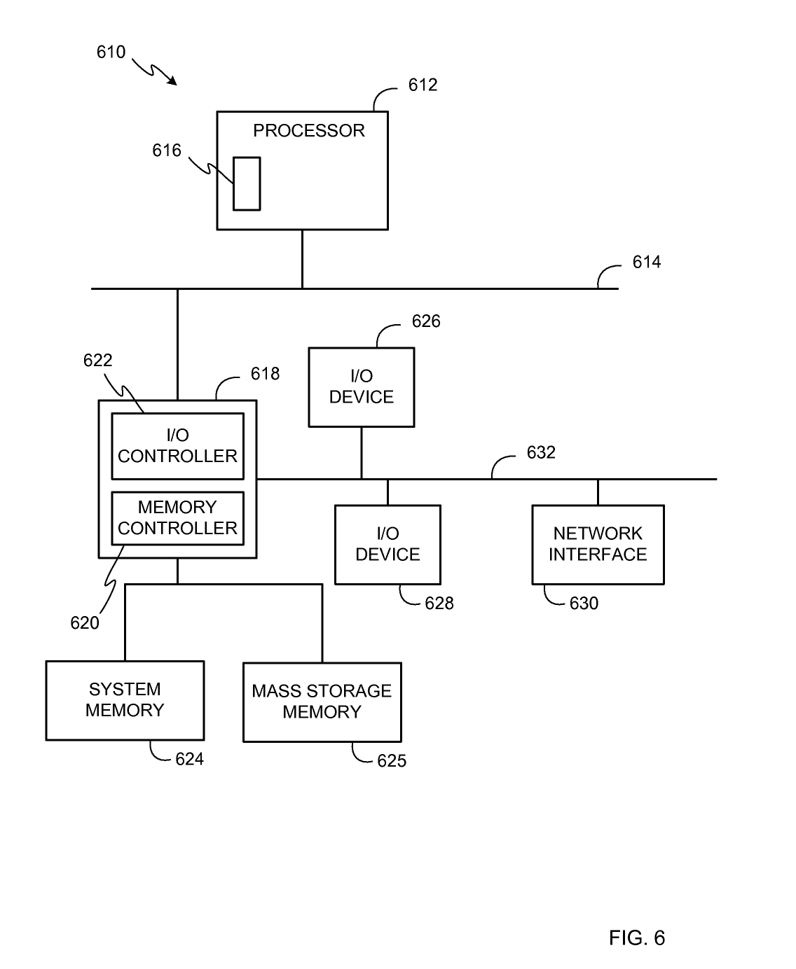

FIG. 4 is an example apparatus 400 configured to decode and/or encode video information using a plurality of threads (e.g., the plurality of threads 104a-d of FIGS. 1-3). The example apparatus 400 may be implemented using any desired combination of hardware, firmware, and/or software. For example, one or more integrated circuits, discrete semiconductor components, or passive electronic components may be used. Additionally or alternatively, some or all of the blocks of the example apparatus 400, or parts thereof, may be implemented using instructions, code, and/or other software and/or firmware, etc. stored on a machine accessible medium that, when executed by, for example, a processor system (e.g., the example processor system 610 of FIG. 6), perform the operations represented in the flow diagram of FIGS. 5A and 5B. Although the example apparatus 400 is described as having one of each block described below, the example apparatus 400 may be provided with two or more of any block described below. For example, the example apparatus 400 may be provided with two or more of a particular block, each of which is configured to be executed by a respective one of a plurality of threads (e.g., the threads 104a-d of FIG. 1).

To select video frames to decode (or encode), the example apparatus 400 is provided with a frame selector 402. In the illustrated example, the frame selector 402 is configured to select one of the video frames 102a-d (FIGS. 1-3) for each of the threads 104a-d (FIGS. 1-3). For example, when one of the threads 104a-d finishes decoding (or encoding) one of the frames 102a-d, the frame selector 402 can select a next video frame (e.g., a frame other than the frames 102a-d already being decoded by the threads 104a-d) for that one of the threads 104a-d to decode (or encode). In an example implementation, the frame selector 402 stores the frame index values of the frames being decoded by the threads 104a-d. In this manner, the frame selector 402 can select in sequential order (e.g., chronological order) a next unprocessed or available frame in the video program when one of the threads 104a-d finishes processing a video frame. In an alternative example implementation, the example apparatus may be provided with a plurality of (e.g., four) frame selectors substantially similar or identical to the frame selector 402. In the alternative example implementation, each of the frame selectors is configured to select video frames for a respective one of the threads 104a-d.

To select macroblocks to decode (or encode), the example apparatus 400 is provided with a macroblock selector 404. In the illustrated example, the macroblock selector 404 is configured to select one of tile macroblocks 106, 108, 110, 112, and 114 (FIG. 1) for the threads 104a-d to process (e.g., decode or encode). For example, to determine which macroblock to select for the thread 104a, the macroblock selector 404 can increment the macroblock index value 116a (e.g., macroblock coordinates (P^{f}ᵣ,P^{f}_{c}) of FIG. 1) of a macroblock previously processed by the thread 104a to determine which macroblock to select next in, for example, a sequential order (e.g., select macroblocks from the upper left corner of the frame first and continue in order toward the lower right corner of the frame). In some example implementations, the macroblock selector 404 may be configured to select macroblocks for all of the threads 104a-d. In other example implementations, the example apparatus 400 may be provided with a plurality of macroblock selectors substantially similar or identical to the macroblock selector 404, and each of the macroblock selectors may be configured to select macroblocks for a respective one of the threads 104a-d.

To detect macroblock types, the example apparatus 400 is provided with a macroblock type detector 406. In the illustrated example, the macroblock type detector 406 is configured to detect whether a macroblock is an intramacroblock (e.g., the intramacroblocks 110 of FIG. 1) or an intermacroblocie (e.g., the predicted macroblocks 112 and 114 of FIG. 1). In other example implementations, the macroblock type detector 406 may be configured to detect other macroblock types. In the illustrated example, the macroblock type detector 406 uses macroblock header information to determine macroblock types. Macroblock header information contains descriptive information about a macroblock indicative of macroblock type and other macroblock attributes.

To decode and/or encode video information (e.g., the video frames 102a-d of FIG. 1), the example apparatus is provided with a video information processing unit 408. In the illustrated example, the video information processing unit 408 includes a video decoder 410 to decode video information and a video encoder 412 to encode video information. In the illustrated example, the video decoder 410 and the video encoder 412 may be configured to process video information using any type of video coding standards (e.g., video compression standards) including, for example, H.263, Moving Picture Expert Group (“MPEG”) standards, H.264, VC-1, etc. In some example implementations, the video information processing unit 408 may be configured to include only one of the video decoder 410 or the video encoder 412.

In an example video decode implementation, when the video information processing unit 408 receives encoded video (e.g., the encoded video information 206 of FIGS. 2 and 3), the video information processing unit 408 selects or enables the video decoder 410 and communicates the encoded video information 206 to the video decoder 410. In an example video encoding implementation, when the video information processing unit 408 receives unencoded video (e.g., the unencoded video information 208 of FIGS. 2 and 3), the video information processing unit 408 selects or enables the video encoder 412 and communicates the unencoded video information 208 to the video encoder 412.

In some example implementations, the frame selector 402 selects video frames to be decoded (or encoded) by each of the threads 102a-d of FIG. 1 and communicates the selected video frames to the information processing unit 408. In other example implementations, the video information processing unit 408 receives encoded or unencoded video information and the video information processing unit 408 uses the frame selector 402 to select video frames for each of the threads 102a-d.

To control the video processing operations of the video information processing unit 408, the example apparatus 400 is provided with an operation controller 414. In the illustrated example, the operation controller 414 is configured to start and stall video decoding or encoding operations performed by the video information processing unit 408. The operation controller 414 may also be configured to control other operations of the video information processing unit 408 (e.g. selecting one of the video decoder 410 or the video encoder 412).

The example apparatus 400 is provided with a macroblock status designator 416 configured to indicate whether macroblocks (e.g., the macroblocks 106, 108, 110, 112, and 114 of FIG. 1) are processed (e.g., decoded or encoded) or unprocessed (e.g., not yet decoded during a decode process or not yet encoded during an encode process). In the illustrated example, the macroblock status designator 4T6 is configured to store macroblock status designators (e.g., processed/unprocessed tagging information) in association with each macroblock of a frame (e.g., the video frames 102a-d of FIG. 1) indicating whether the macroblocks are processed or unprocessed. For example, the macroblock status designator 416 may store the macroblock status designators in a data structure in association with the macroblock index values (e.g., the macroblock index values 116a-d of FIG. 1) identifying macroblocks in video frames. The data structure may be stored in a shared memory (e.g., the memory 216 of FIG. 2 or the memory 306 of FIG. 3).

The example apparatus 400 is provided with a prediction information locator 418 configured to determine the location (e.g., one or more macroblock index or coordinate values) of macroblocks within reference frames (e.g., the frames 102a and 102b of FIG. 1) containing prediction information required to decode predicted macroblocks (e.g., the current predicted macroblocks 1112 and 114 of FIG. 1). In the illustrated example, the prediction information locator 418 is configured to use information (e.g., macroblock header information) in predicted macroblocks to determine macroblock coordinates (P^{f}ᵣ, P^{f}ᵣ) of macroblocks containing prediction information.

The example apparatus 400 is provided with a prediction information availability detector 420 configured to determine whether prediction information in reference frames is available. For example, the prediction information availability detector 420 may check macroblock status designators of macroblocks in reference frames to determine whether macroblocks containing prediction information identified by the prediction information locator 418 have been processed.

To enable processors (e.g. the processors 302a-d of FIG. 3) to communicate with each another in a multi-processor system (e.g., the multi-processor system 300 of FIG. 3), the example apparatus 400 is provided with an inter-processor communication interface 422. The inter-processor communication interface 422 can be configured using any suitable communication interface and communication protocol.

FIGS. 5A and 5B depict a flowchart representative of an example method that may be used to implement the example apparatus 400 of FIG. 4 to decode and/or encode video information. In some example implementations, the example method of FIGS. 5A and 5B may be implemented using machine readable instructions comprising a program for execution by a processor (e.g., the processor 612 shown in the example processor system 610 of FIG. 6). The program may be embodied in software stored on a tangible medium such as a CD-ROM, a floppy disk, a hard drive, a digital versatile disk (DVD), or a memory associated with the processor 612 and/or embodied in firmware and/or dedicated hardware in a well-known manner. Further, although the example program is described with reference to the flowchart illustrated in FIGS. 5A and 5B, persons of ordinary skill in the art will readily appreciate that in many other methods of implementing the example apparatus 400 may alternatively be used. For example, the order of execution of the blocks may be changed, and/or some of the blocks described may be changed, eliminated, or combined.

The example method of FIGS. 5A and 5B is described as implementing the operations associated with one of the threads 104a-b of FIGS. 1-3. However, a plurality of instances of the example method may be executed in parallel to implement operations associated with decoding or encoding video information using two or more of the threads 104a-b. Also, although the operations of the example method of FIGS. 5A and 5B are described as being performed in series, two or more of the operations may be performed in parallel.

Initially, the example apparatus 400 determines whether it should decode video information (block 502). For example, when the example apparatus 400 receives encoded video information (e.g., the encoded video information 206 of FIGS. 2 and 3), thle example apparatus 400 determines that it should decode video information. Alternatively, when the example apparatus 400 is provided with unencoded video information (e.g., the unencoded video information 208 of FIGS. 2 and 3), the example apparatus 400 determines that it should encode video information and, thus, it should not decode video information.

If the example apparatus 400 determines that it should decode video information (block 502), the frame selector 402 (FIG. 4) selects a frame (e.g., one of the video frames 102a-d of FIGS. 1-3) to decode (block 504). The macroblock status designator 416 (FIG. 4) then designates all the macroblocks in the selected frame as not processed (block 506). The macroblock selector 404 then selects a macroblock to decode (block 508) and sets the macroblock index value (block 5110) (e.g., one of tile macroblock index values 116a-d of FIG. 1) to indicate the selected macroblock. For example, in the illustrated example of FIG. 1, if the frame selector 402 selected the first frame 102a at block 504, the macroblock selector 404 selects the current intramacroblock 110 at block 508 for decoding by tile first thread 104a. To determine which macroblock to select, the macroblock selector 404 can increment the macroblock index value of the previously processed macroblock to determine which macroblock to select next.

The video decoder 410 (FIG. 4) then decodes macroblock header information (e.g., macroblock descriptive information) (block 512) of the selected macroblock. The macroblock header information contains descriptive information about the macroblock indicative of macroblock type and other macroblock attributes. The macroblock type detector 406 (FIG. 4) then determines whether the selected macroblock is an intramacroblock (block 514) based on, for example, the header information decoded at block 512.

If tile macroblock type detector 406 determines that tile selected macroblock is not an intramacroblock (block 514) (e.g., the selected macroblock is a predicted macroblock requiring prediction information), the prediction information locator 418 determines the location (e.g., macroblock coordinates (P^{f}ᵣ, P^{f}_{c})) of macroblock(s) within one or more reference frame(s) containing the prediction information (block 516) required to decode tile selected frame based on, for example, the header information decoded at block 512.

The operation controller 414 (FIG. 4) then stalls the decoding operation (e.g., the processing operation) performed by the video decoder 410 on the selected macrolbock and waits until the prediction information availability detector 420 determines that the macroblock(s) containing the prediction information are processed (block 51 S). In the illustrated example of FIG. 1, the video decoding operation of the second thread 104b needs to be stalled until the decoding operation of the first thread 104a decodes the macroblocks containing prediction information required by the second thread 104b to decode the current predicted macrablock 112. In the illustrated example, the prediction information availability detector 420 can access a shared memory (e.g., the memory 216 of FIG. 2 or the memory 306 of FIG. 3) to retrieve macroblock status designators associated with the first frame 104a (FIG. 1) corresponding to the macroblock(s) containing the prediction information. If the prediction information availability detector 420 determines that the retrieved macroblock status designators indicate the macroblock(s) are processed, then the operation controller 414 restarts, enables, or otherwise causes the video decoder 410 to continue the decoding operation of the selected macroblock via the second thread 104b by retrieving the prediction information from the first frame 102a (e.g., the reference frame) and using tile prediction information to decode the selected macroblock.

In some example implementations, the operation controller 414 need not stall and wait for prediction information. In the illustrated example of FIG. 1, the video decoding operation of the third thread 104c need not be stalled because the macroblocks of the second frame 102b (e.g., the reference frame) having the prediction information required by the third thread 104c to decode the current predicted macroblock 114 have already been decoded by the second thread 104b. Thus, in the illustrated example of the third frame 102c, the operation controller 414 need not stall the decoding operation of the third thread 104c to wait for the prediction information.

When the prediction information availability detector 420 determines that the prediction information is available or if the macrobloclk type detector 406 determines that the selected macroblock is an intramacroblock (block 514), the operation controller 414 restarts or enables the decoding operation performed by the video decoder 410 on the selected macroblock (block 520). After the selected macroblock is decoded, the macroblock status designator 416 (FIG. 4) designates the selected macroblock as processed (block 522) by, for example, updating a status designator associated with the selected macroblock in a shared memory (e.g., the memory 216 of FIG. 2 or the memory 306 of FIG. 3). The example apparatus 400 then determines whether another macroblock in the current frame requires decoding (block 524). If another macroblock requires decoding (block 524), control is passed back to block 508 and the macroblock is selected. Otherwise, the process is ended and/or control returns to a calling process or function.

In an example video encoding implementation, if the example apparatus 400 receives unencoded video information (e.g., the unencoded video information 208 of FIGS. 2 and 3), at block 502 the example apparatus 400 determines that it should not decode video and control is passed to block 532 of FIG. 5B. The frame selector 402 (FIG. 4) selects a frame (e.g., one of the video frames 102a-d of FIG. 1) to encode (block 532). The macroblock status designator 416 (FIG. 4) then designates all the macroblocks in the selected frame as not processed (block 534).

The video encoder 412 then generates motion vectors for the selected frame (block 536) using a motion estimation process to identify the prediction information in the reference frame and determine which macroblocks of the selected frame are predicted macroblocks (block 540). The macroblock selector 404 (FIG. 4) then selects a macroblock to encode (block 542) and sets the macroblock index value (block 544) (e.g., one of the macrobloclk index values 116a-d of FIG. 1) to indicate the selected macroblock. The macroblock type detector 406 (FIG. 4) then determines whether the selected macroblock is an intrainacroblock (block 546) based on, for example, the analysis of the motion vectors performed at block 540.

If the macroblock type detector 406 determines that the selected macroblock is not an intramacroblock (block 546), the prediction information locator 418 (FIG. 4) determines the location (e.g., the macroblock coordinates (P^{f}ᵣ, P^{f}_{c})) of macroblock(s) within one or more reference frame(s) containing the prediction information (block 548). The video encoder 412 then encodes the macroblock type and the prediction information location (block 550).

The operation controller 414 then stalls the encoding operation (e.g., the processing operation) performed by the video encoder 412 on the selected macroblock and waits until the prediction information availability detector 420 determines that the macroblock(s) containing the prediction information are processed (block 552). In this manner, the video encoder 412 can use the prediction information to encode the selected macroblock.

After the prediction information availability detector 420 determines that the macroblock(s) containing the prediction information are processed or if the macroblock type detector 406 determines that the selected macroblock is an intramacroblock (block 546), the operation controller 414 causes the video encoder 412 to encode (e.g., compress) the selected macroblock (block 554). After the selected macroblock is encoded, the macroblock status designator 416 designates the selected macroblock as processed (block 556). The example apparatus 400 then determines whether another macroblock in the current frame requires encoding (block 558). If another macroblock requires encoding (block 558), control is passed back to block 542 and the macroblock is selected. Otherwise, the process is ended and/or control returns to a calling process or function.

In an example implementation, the example process of FIGS. 5A and 5B may be used to implement an example hybrid video decoding process and/or hybrid video encoding process in which one or more threads process a first plurality of frames in a sequential manner and one or more other threads decode a second plurality of frames in a parallel manner. For example, a hybrid decoding process may be divided into a serial decode sub-process and a parallel decode sub-process. The serial decode sub-process is implemented using operations used to decode frames serially (e.g., decode a frame before decoding a subsequent frame). The parallel decode sub-process is implemented using operations used to decode frames in parallel (e.g., decode two or more frames in parallel). The serial decode sub-process may be configured to use a single thread (or a plurality of threads) to decode one or more frames in a serial manner, and the parallel decode sub-process may be configured to use a plurality of threads to decode two or more frames in parallel by using each of the plurality of threads to decode a respective frame.

FIG. 6 is a block diagram of an example processor system 610 that may be used to implement the apparatus and methods described herein. As shown in FIG. 6, the processor system 610 includes a processor 612 that is coupled to an interconnection bus 614. The processor 612 includes a register set or register space 616, which is depicted in FIG. 6 as being entirely on-chip, but which could alternatively be located entirely or partially off-chip and directly coupled to the processor 612 via dedicated electrical connections and/or via the interconnection bus 614. The processor 612 may be any suitable processor, processing unit or microprocessor. Although not shown in FIG. 6, the system 610 may be a multi-processor system and thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides 1(0 and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SIAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 6 10 to communicate with another processor system.

While the memory controller 620 and the I/O controller 622 are depicted in FIG. 6 as separate functional blocks within the chipset 618, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method, comprising:
selecting a video frame;
selecting a macroblock of the video frame to process;
initiating a processing operation of the selected macroblock by a first thread, wherein the processing operation involves one of decoding the macroblock or encoding the macroblock; and
when prediction information is required from a second frame being decoded or encoded by a second thread, stalling the processing operation of the selected macroblock by the first thread until the prediction information is available.

2. A method as defined in claim 1, further comprising marking a plurality of macroblocks in the video frame as not processed.

3. A method as defined in claim 2, wherein the plurality of macroblocks in the video frame includes all of the macroblocks in the video frame.

4. A method as defined in claim 2, wherein marking the plurality of macroblocks in the video frame as not processed indicates that the plurality of macroblocks are not ready to provide prediction information to a third thread to decode or encode a third video frame.

5. A method as defined in claim 1, further comprising when the first thread finishes processing the selected macroblock, marking the selected macroblock as processed.

6. A method as defined in claim 1, further comprising setting a macroblock index value corresponding to the selected macroblock.

7. A method as defined in claim 6, wherein setting the macroblock index value includes setting a column number and a row number indicating a coordinate location of the selected macroblock within the video frame.

8. A method as defined in claim 1, wherein the processing operation is associated with a Moving Pictures Expert Group algorithm.

9. A method as defined in claim 1, further comprising detecting a macroblock type of the selected macroblock.

10. A method as defined in claim 9, further comprising determining that the prediction information is required when the macroblock type is not an intramacroblock type.

11. A method as defined in claim 1, further comprising determining coordinates of a region in the second frame having at least some of the prediction information.

12. A method as defined in claim 1, wherein stalling the processing operation of the selected macroblock until the prediction information is available comprises stalling the processing operation of the selected macroblock until the second thread has processed at least one reference macroblock including the at least some of the prediction information.

13. A method as defined in claim 1, wherein the first thread is executed by a first processor and the second thread is executed by a second processor.

14. An apparatus, comprising:
a video information processing unit configured to use a first thread to perform a processing operation on a first macroblock, wherein the processing operation includes one of a decode operation or an encode operation; and
an operation controller configured to stall the processing operation of the first macroblock by the first thread when prediction information is required from a second frame being decoded or encoded by a second thread and the prediction information is not yet available.

15. An apparatus as defined in claim 14, further comprising a macroblock status designator configured to designate the first macroblock as not processed prior to performing the processing operation on the first macroblock.

16. An apparatus as defined in claim 15, wherein the macroblock status designator is configured to designate the first macroblock as processed after performing the processing operation on the first macroblock.

17. An apparatus as defined in claim 14, further comprising a macroblock type detector configured to determine the macroblock type of the first macroblock.

18. An apparatus as defined in claim 17, wherein the operation controller is configured to stall the processing operation of the first macroblock by the first thread when the macroblock type detector determines the macroblock type of the first macroblock is not an intramacroblock type.

19. An apparatus as defined in claim 14, further comprising a prediction information availability detector configured to determine when the prediction information is available by determining when the second thread has processed at least one reference macroblock including the prediction information.

20. An apparatus as defined in claim 19, wherein the prediction information availability detector is configured to determine when the prediction information is available based on a macroblock index value associated with the second frame indicative of a reference macroblock being decoded or encoded by the second thread.

21. An apparatus as defined in claim 14, further comprising a macroblock selector configured to set a macroblock index value corresponding to the first macroblock, wherein the macroblock index value is accessible by the second thread.

22. An apparatus as defined in claim 14, further comprising an inter-processor communication interface configured to enable communications between a first processor and a second processor wherein the first processor executes the first thread and the second processor executes the second thread.

23. A machine accessible medium having instructions stored thereon that, when executed, cause a machine to:
select a video frame;
select a macroblock of the video frame to process;
initiate a processing operation of the selected macroblock by a first thread, wherein the processing operation involves one of decoding the macroblock or encoding the macroblock; and
when prediction information is required from a second frame being decoded or encoded by a second thread, stall the processing operation of the selected macroblock by the first thread until the prediction information is available.

24. A machine accessible medium as defined in claim 23 having instructions stored thereon that, when executed, cause the machine to mark a plurality of macroblocks in the video frame as not processed to indicate that the plurality of macro blocks are not ready to provide prediction information to a third thread to decode or encode a third video frame.

25. A machine accessible medium as defined in claim 23 having instructions stored thereon that, when executed, cause the machine to set a macroblock index value corresponding to the selected macroblock.

26. A machine accessible medium as defined in claim 25 having instructions stored thereon that, when executed, cause the machine to set the macroblock index value by setting a column number and a row number indicating a coordinate location of the selected macroblock within the video frame.

27. A machine accessible medium as defined in claim 23 having instructions stored thereon that, when executed, cause the machine to determine that the prediction information is required based on a macroblock type of the selected macroblock.

28. A machine accessible medium as defined in claim 27, wherein the prediction information is required when the macroblock type is an intermacroblocic.

29. A machine accessible medium as defined in claim 23 having instructions stored thereon that, when executed, cause the machine to stall the processing operation of the selected macroblock until the prediction information is available by stalling the processing operation of the selected macroblock until the second thread has processed at least one reference macroblock including the prediction information.

30. A machine accessible medium as defined in claim 23 having instructions stored thereon that, when executed, cause the machine to enable communication between a first processor executing the first thread and a second processor executing the second thread.
